(19) United States
(12) Patent Application Publication
(10) Pub. No.: US 2009/0132257 A1
(43) Pub. Date: May 21, 2009

(54) System and method for inputting edited translation words or sentence

(75) Inventors: Chaucer Chiu, Taipei (TW); Jenny Xu, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/984,454

(22) Filed: Nov. 19, 2007

(51) Int. Cl. G10L 15/22

(52) U.S. Cl. 704/276; 704/E15.04

(57) ABSTRACT

A system and a method for inputting edited translation words or sentence are provided to solve the problem that editing translation words or sentence and inputting the edited translation words or sentence cannot be performed by successive actions. In this system and method, the input words or sentence input into an input region by a user are intercepted and translated into translation words or sentence, and a function of editing the translation words or sentence is provided in a display region for displaying the translation words or sentence, thereby achieving the efficacy of inputting the edited translation words or sentence into the input region directly.

### BACKGROUND OF THE INVENTION

1. Field of Invention

The present invention relates to an input system and method, and more particularly, to a system and a method for inputting edited translation words or sentence.

2. Related Art

Translation software analyzes input sentence, and then translates the input sentence into translation sentence, which substantially is an application of comprehension of natural language and also is a main project of natural language processing technology. The current translation software can convert input sentence into understandable translation sentence to some extent. However, if meaningful translation sentence are required, it is generally necessary to input sentence in a proper manner for the translation software to analyze.

When using the translation software to perform translation, generally, a translation interface is additionally used to translate the input words or sentence into translation words or sentence, that is to say, first, the input words or sentence are copied to the translation interface for translation, and the translated translation words or sentence are copied to an input region; or alternatively, when the software/interface to be translated has a translation plug-in, the translation plug-in is enabled first, the input words or sentence to be translated are selected in the software/interface, and the translation plug-in translates the input words or sentence into translation words or sentence. In view of the above, when translating the input words or sentence into translation words or sentence and inputting the translation words or sentence to non-translation software, several discontinuous actions are always required. Additionally, the current translation software/plug-in cannot translate the input words or sentence into perfect translation words or sentence. Therefore, the user still is required to edit the translation words or sentence after the translation of the translation software/plug-in. Therefore, the whole actions of editing and then inputting the translation words or sentence are quite indirect, thereby causing inconvenience to the user.

### SUMMARY OF THE INVENTION

In view of the situation that the conventional translation software in prior art cannot smoothly edit and then input translation words or sentence generated by translating the input words or sentence, the present invention is directed to provide a system and a method for inputting edited translation words or sentence, which can solve the problem that the translation words or sentence generated by translating the input words or sentence cannot be edited and then input by successive actions.

The system for inputting edited translation words or sentence of the present invention includes an intercept module, a translation module, a display module, an edit module, and an input module. The words or sentence input by the user and intercept by the intercept module are translated into translation words or sentence through the translation module, and then the display module displays the translation words or sentence. After the user edits the translation words or sentence through the edit module, the input module inputs the edited translation words or sentence, so as to solve the problem that editing the translation words or sentence and inputting the edited translation words or sentence cannot be performed by successive actions.

The method for inputting edited translation words or sentence of the present invention includes: intercepting the input words or sentence input into an input region; translating the input words or sentence to generate translation words or sentence; displaying the translation words or sentence in a display region; editing the translation words or sentence in the display region; and inputting the edited translation words or sentence into the input region. Therefore, by displaying the translation words or sentence in the display region for the user to edit, the problem that editing the translation words or sentence and inputting the edited translation words or sentence cannot be performed by successive actions is solved.

Compared with the conventional translation software, which cannot smoothly edit the translation words or sentence and then input the edited translation words or sentence, the present invention can achieve the efficacy of translating the input words or sentence into translation words or sentence and editing the translation words or sentence, and can solve the problem that editing the translation words or sentence and inputting the edited translation words or sentence cannot be performed by successive actions.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is an architectural view of a system for inputting edited translation words or sentence of the present invention.

FIG. 2 is a flowchart of a method for inputting edited translation words or sentence of the present invention.

FIG. 3A is a schematic view of displaying translation words or sentence according to an embodiment of the present invention.

FIG. 3B a schematic view of displaying translation words or sentence according to an embodiment of the present invention.

FIG. 3C is a schematic view of finishing the edition of translation words or sentence according to an embodiment of the present invention.

FIG. 3D is a schematic view of inputting edited translation words or sentence according to an embodiment of the present invention.

### DETAILED DESCRIPTION OF THE INVENTION

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings.

Those Chinese characters shown in the following descriptions or in the drawings are just mentioned for describing the embodiments and are substantially irrelevant to any technical matters.

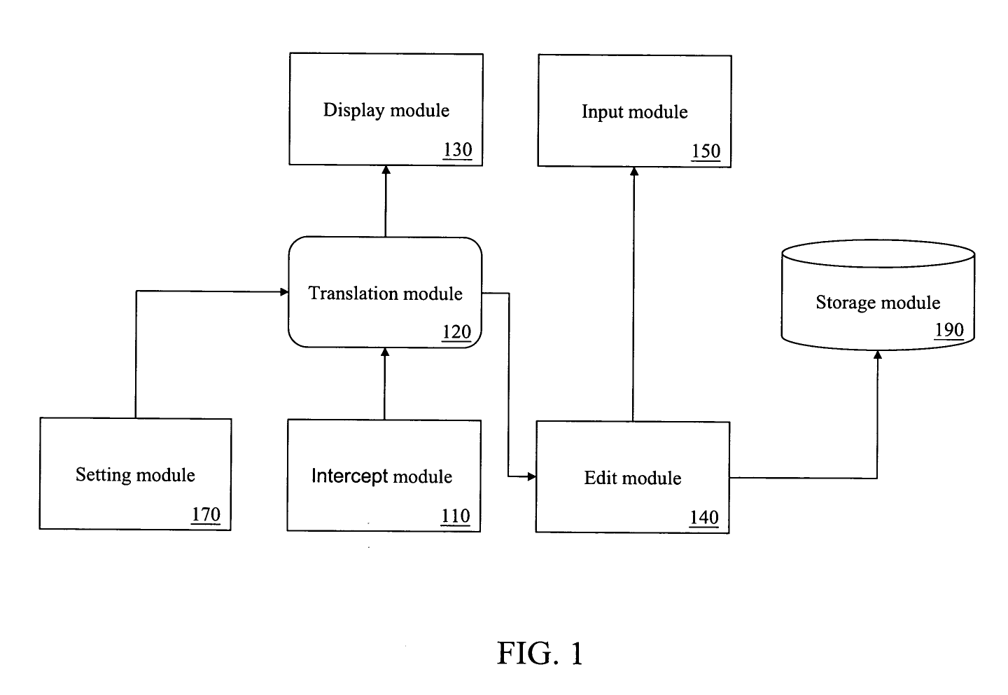

First, the operation of the system of the present invention is illustrated below with reference to an architectural view of a system for inputting edited translation words or sentence of the present invention in FIG. 1. As shown in FIG. 1, the system of the present invention includes an intercept module 110, a translation module 120, a display module 130, an edit module 140, an input module 150, a setting module 170, and a storage module 190.

The intercept module 110 is used for intercepting input words or sentence input into an input region by a user. The intercept module 110 continuously detects whether any data (including full-form character and half-form character) is input by the user. When the intercept module 110 detects that some data is input, it intercepts the input data. After combining the recently intercepted data and the previously intercepted data, the intercept module 110 defines the combined data as input words or sentence.

The translation module 120 is used for translating the input words or sentence intercepted by the intercept module 110 into translation words or sentence.

The display module 130 is used for displaying the translation words or sentence generated by translating the input words or sentence by the translation module 120 in the display region. For example, when the user inputs a words or sentence in the input region of a text editing software, the display region is not an input region of the text editing software, and a region, such as a floating window and a pop-up window, can be used to form a display region to display the translation words or sentence. However, the display region of the present invention is not limited to the above two types, and any region that can display and edit texts can be used in the present invention.

The edit module 140 is used for the user to edit the translation words or sentence generated by the translation module 120 in the display region displayed by the display module 130.

The input module 150 is used for inputting the edited translation words or sentence to the same input region as that for inputting the words or sentence after the user has edited the translation words or sentence in the display region.

Furthermore, the present invention further includes a setting module 170, which is used for setting a language of the input words or sentence intercepted by the intercept module 110 and a language of the translation words or sentence translated by the translation module 120, thereby avoiding translation errors caused by language recognition errors. For example, the language of the input words or sentence is set as Chinese, while the language of the translation words or sentence is set as English, but the set language of the present invention is not limited to Chinese or English.

Furthermore, the present invention further includes a storage module 190, which is used for storing the texts different before and after the edition of the user, after the user has edited the translation words or sentence generated by the translation of the translation module 120 into edited translation words or sentence, such that when the translation module 120 translates the same text as that before edition again, it can use the edited text stored in the storage module 190 to perform the translation.

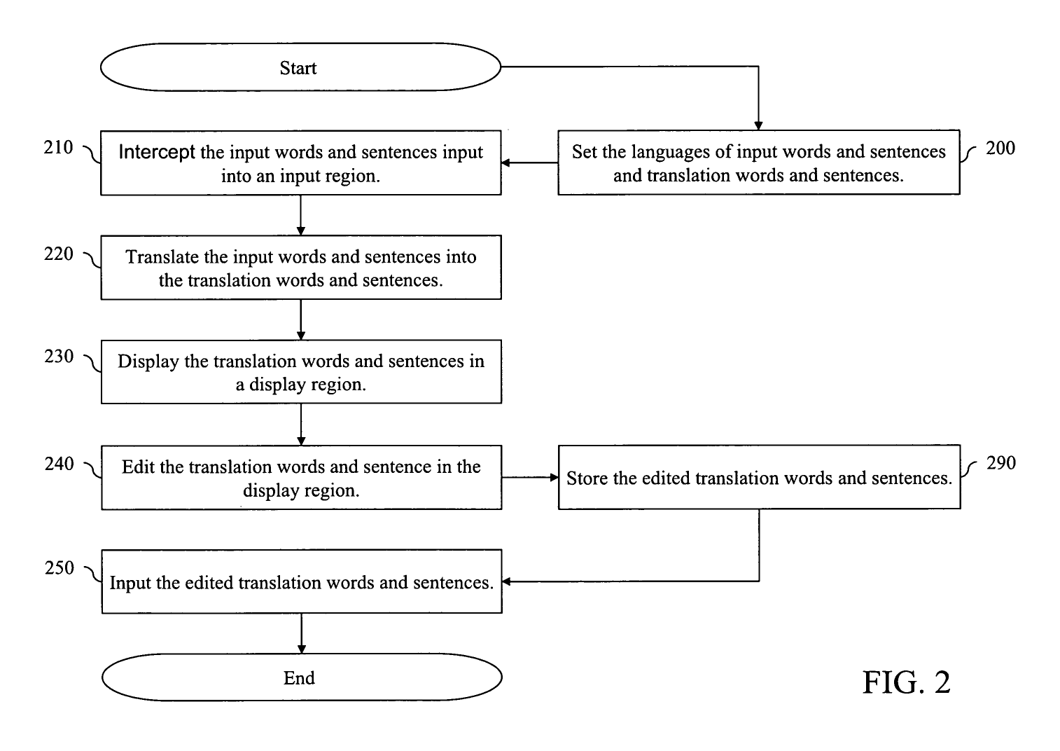

Then, the operating system and method of the present invention are illustrated through an embodiment. Referring to FIGS. 1 and 2, an architectural view of a system for inputting edited translation words or sentence of the present invention and a flowchart of a method for inputting edited translation words or sentence of the present invention are shown respectively.

In this embodiment, the input region for the user to input the input sentence is an input region of a real-time communication software, but the present invention is not limited to this, and any region for inputting test can be used in the present invention. In this embodiment, the display module 130 displays the translation sentence by means of a floating window, but the present invention is not limited to this. In this embodiment, the input sentence [symbol] [symbol] is an example, but the input sentence of the present invention is not limited to this.

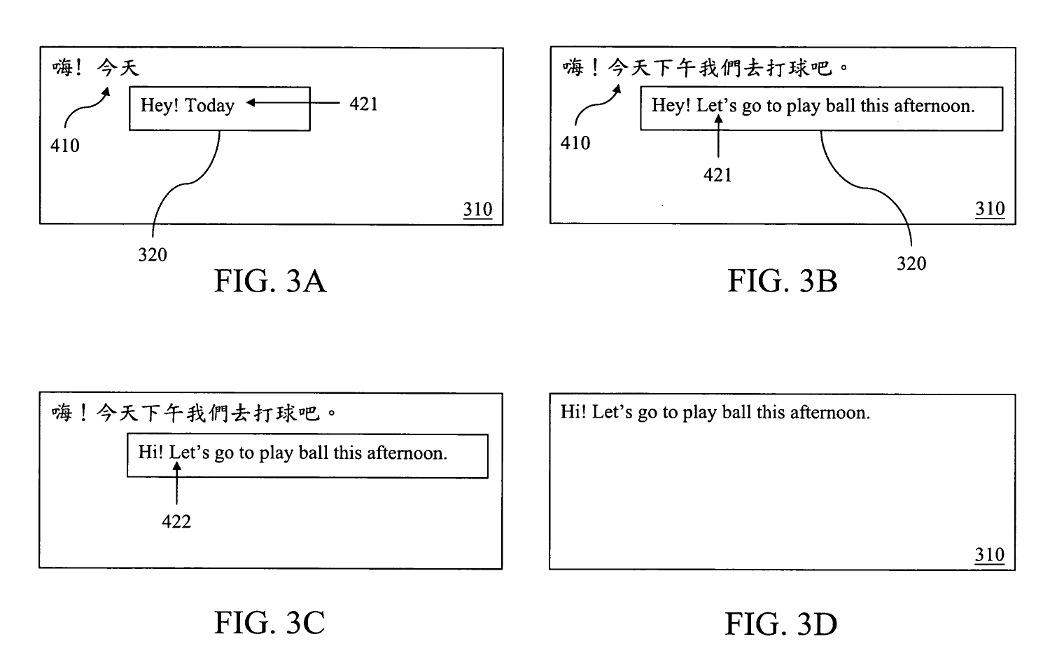

As shown in FIG. 3A, when the user uses the present invention, first, he/she inputs input sentence 410 in an input region 310 of a real-time communication software. At this time, the intercept module 110 intercepts the input sentence 410 input by the user (Step 210). The intercept module 110 intercepts the input sentence 410 input by the user by mans of hooking, but the manner of intercepting the input sentence in the present invention is not limited to hooking.

After the intercept module 110 intercepts the input sentence 410 input by the user (Step 210), the translation module 120 translates the input sentence 410 intercepted by the intercept module 110 (Step 220), and then the display module 130 displays translation sentence 421 generated by translating the input sentence 410 by a floating window (a display region 320) (Step 230).

When the input sentence 410 input by the user and intercepted by the intercept module 110 are [symbol] , the translation module 120 translates the input sentence 410 [symbol] input by the user into the translation sentence 421 “Hey! Today”, and the display module 130 display “Hey! Today” by a floating window. When the user keeps inputting characters, and the input sentence 410 become [symbol] [symbol] , as shown in FIG. 3B, the intercept module 110 intercepts the same input sentence 410 as that input by the user, i.e., [symbol] [symbol] , and the translation module 120 translates the input sentence 410 into the translation sentence 421 “Hey! Let's go to play ball this afternoon.”, and then the display module 130 displays the translation sentence 421 in the floating window.

After the display module 130 displays the translation sentence 410 (Step 230), the user edits the translation sentence 421 in the floating window (Step 240). The user can edit the translation sentence 421 by, for example, clicking the site that the user wants to edit in the floating window, but the present invention is not limited to this. If the user wants to edit the first word “Hey” of the translation sentence 421 into “Hi”, accordingly, as shown in FIG. 3C, the user will delete “ey” and input “i”, so as to generate edited translation sentence 422 “Hi! Let's go to play ball this afternoon.”.

After the user has edited the translation sentence 422 (Step 240), the input module 150 inputs the edited translation sentence 422 into the input region 310 of the real-time communication software (Step 250), as shown in FIG. 3D. In such a manner, the present invention can solve the problem that the conventional translation software cannot edit the translation sentence and then input the edited translation sentence by successive actions.

Generally, the user of the above embodiment hopes that the transmitted information is the edited translation sentence 422. When the input module 150 inputs the edited translation sentence 422 into the input region 310 (Step 250), the input sentence 410 in the input region 310 can be replaced with the edited translation sentence 422.

Additionally, in order to avoid translation errors caused by language recognition errors, before the translation module 120 translates the input sentence 410 intercepted by the intercept module 110 (Step 220), the setting module 170 that can be added to the present invention for setting the languages of the input sentence and the translation sentence 421 (Step 200). The step of setting the input sentence 410 and the translation sentence 421 by the setting module 170 is not limited to be performed before, during, or after the intercept module 110 intercepts the input sentence 410 (Step 210), but generally, the setting module 170 will perform the setting before the intercept module 110 intercepts the input sentence 410. For example, in this embodiment, the user can set the input sentence 410 to be Chinese and the translation sentence 421 to be English through the setting module 170, but the languages set by the setting module 170 of the present invention are not limited to Chinese and English.

Additionally, after the user edits the translation sentence 421 into the edited translation sentence 422 (Step 240), the storage module 190 that can be added to the present invention for storing the text different before and after the edition of the user (Step 290), such that when the translation module 120 translates the same input sentence 410 again, the text edited by the user and stored in the storage module 190 can be used to perform the translation. For example, when the user inputs “ [symbol] ” again, the translation module 120 finds in the storage module 190 that the user has edited the initially translation “Hey” into “Hi” last time, so the translation module 120 will translate “ [symbol] ” input this time into “Hi”.

Furthermore, the translation method of modifying the translation results provided by the present invention can be realized in hardware, software, or a combination of hardware and software, and also can be realized in an integrated manner in a computer system or be realized in a scattered manner in several interconnected computer systems with different devices dispersed therein.

Although the present invention is disclosed as above with preferable embodiments, it is not limited to the disclosure of the embodiments, and it will be apparent to those skilled in the art that various alternations and modifications can be made without departing from the scope or spirit of the invention. Therefore, the protection scope of the present invention depends on those defined by the scope of the following claims.

What is claimed is:

1. A method for inputting edited translation words or sentence, comprising:
intercepting an input words or sentence input to an input region;
translating the input words or sentence to generate a translation words or sentence;
displaying the translation words or sentence in a display region;
editing the translation words or sentence in the display region; and
inputting the edited translation words or sentence into the input region.

2. The method for inputting edited translation words or sentence as claimed in claim 1, further comprising a step of setting a language of the input words or sentence and a language of the translation words or sentence.

3. The method for inputting edited translation words or sentence as claimed in claim 1, further comprising a step of storing texts different in the translation words or sentence and the edited translation words or sentence.

4. A system for inputting edited translation words or sentence, comprising:
an intercept module, for intercepting an input words or sentence input into an input region;
a translation module, for translating the input words or sentence into a translation words or sentence;
a display module, for displaying the translation words or sentence in the display region;
an edit module, for editing the translation words or sentence in the display region; and
an input module, for input the edited translation words or sentence into the input region.

5. The system for inputting edited translation words or sentence as claimed in claim 4, wherein the display region is a floating window.

6. The system for inputting edited translation words or sentence as claimed in claim 4, further comprising a setting module for setting a language of the input words or sentence and a language of the translation words or sentence.

7. The system for inputting edited translation words or sentence as claimed in claim 4, further comprising a storage module for storing texts different in the translation words or sentence and the edited translation words or sentence.
